(19) United States
(12) Patent Application Publication
(10) Pub. No.: US 2011/0309044 A1
(43) Pub. Date: Dec. 22, 2011

(54) Snap on Shelf Slotting Tool and Lane Indicator

(76) Inventor: Michael Phillip Morrow, Heath, OH (US)

(21) Appl. No.: 13/165,540

(22) Filed: Jun. 21, 2011

Related U.S. Application Data
(60) Provisional application No. 61/356,737, filed on Jun. 21, 2010.

(51) Int. Cl. A47F 1/04; G09F 3/00; G09F 3/18; A47B 96/04

(52) U.S. Cl. 211/59.2; 211/184; 40/299.01

(57) ABSTRACT

The invention is embodied in an shelving system especially useful for carton flow warehouse shelving systems. The new system provides for carton flow lanes by mounting a series of shelf slotters along the replenish side shelf rail. Goods, typically in boxes, are placed into slots or lanes on the shelf platform, as guided by the shelf slotters. The series of parallel rollers allows the goods to travel down the shelf platform. Once the goods are directed into a lane by the shelf slotters, they will travel under the force of gravity down the roller tracks without significant deviation in their path, eliminating the need for a lane divider and reducing the labor involved in re-profiling a carton flow shelving system.

### CROSS-REFERENCE TO RELATED APPLICATIONS

This application claims priority to U.S. Provisional Application Ser. No. 61/356,737, filed Jun. 21, 2010.

### STATEMENT REGARDING FEDERALLY SPONSORED RESEARCH

None.

### BACKGROUND OF THE INVENTION

The present invention relates generally to the design and configuration of mechanical devices, and more specifically to snap on shelf slotting tools and lane indicators for use in warehousing facilities.

Modern warehousing facilities provide product storage locations and distribution points for enormous quantities of goods. With the popularity of and cost savings associated with internet shopping ever increasing, many retailers assemble individual orders at and ship directly from these warehouses. The demand for small quantity, individually placed orders has been on the rise for decades, almost since the advent of mail-order catalogs. Retailers and warehouse owners have thus continuously searched for ways to increase the efficiency of filling these orders. Distribution systems and methods employed by retail chains with physical locations may also distribute to smaller sized stores in smaller quantities, in order to have the ability to locate more stores in closer proximity to their customers, or to maintain lower local inventories while remaining responsive to consumer demands.

Warehousing facility operators have developed picking, or piece-picking strategies, to more efficiently distribute and ship goods in order to meet the need to fulfill small quantity orders. Goods often arrive at a warehouse in cartons (also referred to as cases or storage boxes) containing a certain quantity of retail-packaged goods, and are stored in this form. As individual orders are filled and shipped, the “pickers” (i.e., warehouse workers filling individual orders) remove the requested quantity of goods from the next open carton. To carry out these strategies, the current state of the art provides for certain arrangements of the goods in the warehouse. The common arrangement at such a facility involves many aisles of vertically stacked shelving (often referred to as “carton flow shelving”) on which retail goods rest. The aisles can each consist of one long shelving unit, or a plurality of modular shelving sections, each stacked side by side to create an aisle of continuous shelving. A section of shelving will typically have three levels of shelving per aisle, although each application will vary as to the number of shelves, depending on the size of the goods involved, space limitations, and other such considerations.

The gravity feed place-pick shelving system has a long history, dating at least to the Display and Delivery device of Shield et al., in U.S. Pat. No. 2,443,871, issued Jun. 22, 1948. A wide variety of modifications of the Shield system have been created. For additional examples, and examples of other shelving systems, see Automatic forward feed shelf, U.S. Pat. No. 4,238,022 to Williams; Gravity feed shelf, U.S. Pat. No. 4,314,648 to Spamer; and Storage rack, U.S. Pat. No. 5,624,045 to Highsmith, et al.

Each individual carton flow shelf has four sides that make up its boundary: a replenishing side, a picking side, and two lateral sides. The floor of each shelf consists of a number of roller strips, or tracks, containing wheel bearings that facilitate the travel of cartons along the shelf floor. When goods arrive at a warehouse, they are offloaded from the transport vehicle and inventoried, where each particular good is accounted for and assigned to a distinct shelf location (or multiple locations) on which that product will be stored. Because shelves are usually much larger than the size of the packaged goods, each location is actually a “lane” or portion of the shelf, its width being dependent on the carton size for that particular good. A lane is thus a row of cartons with product to pick from to fulfill individual orders. The goods are moved to the assigned shelving location, where they are placed onto the shelf at its replenishing side. The shelves are typically configured with their replenishing sides elevated in relation to the picking sides, so that a carton placed onto the rollers from the replenishing side and released will be pulled by gravity down toward the picking side of the shelf.

Each lane is configured to hold cartons of a particular product or type of good, as designated by the warehouse manager. Prior to placing the product cartons on the lane, the lane must be defined. Defining a lane entails positioning roller tracks and guides so that the carton size is accommodated, and recording the lane location in a master inventory list. The roller tracks in the shelving floors are removable. Each roller track consists of a roller track frame onto which wheels and bearings are seated. The roller track frames are generally long and narrow, and attach at their furthest ends to both the replenishing side and to the picking side, with the wheel's rotational axes being oriented perpendicularly thereto (i.e., parallel to the replenishment and picking sides of the shelf). In this configuration, then, the wheels spin in a front and back direction, aiding gravity in pulling the cartons toward the picking side. A common configuration of roller tracks will entail two or more tracks spaced symmetrically about the centerline of the carton lane so as to evenly distribute the weight of the goods between the tracks.

Each lane will also be defined at its boundaries by long, full-length guides, often made of thin metal, but not limited thereto. These guides are positioned on each side of a lane, define the width of each lane, and space apart each adjacent lane from its neighbor. From the replenishment side of the shelves, those persons placing the newly received cartons onto their proper lanes can see the appropriate location for the carton by viewing the tops of the guides that stick out above the base of the shelf. Thus, replenishing operations may be conducted without the worker having the need to line up the carton visually with the cartons positioned on the lane toward the picking side of the shelf before releasing the carton and allowing gravity to pull it down the lane.

From the picking side of the shelves, each lane is marked with the product identifier (e.g., a bar code, a color code, a product name, etc.). When searching for a particular product needed to fill an order, a picker will identify the product location, travel to the identified location, and remove the requested quantity of the product required to fill the order from the open carton at the picking side of the product lane. Additional cartons of the product are positioned behind the lead carton in the lane. As the pickers deplete the lead cartons of product, empty containers are removed and gravity causes the next carton to roll toward the picking side of the shelf.

As most modern warehouses are extremely large in size, it is highly desirable, and profitable, to physically locate the most popular products in a manner that reduces picker travel time. If a picker is required to travel long distances to fill orders, the efficiency of that worker (i.e., orders filled per hour) is greatly reduced. Therefore, a warehouse inventory manager will design the placement of products in a manner that maximizes efficiency based upon product demand. A problem arises after a short time, however, because of changes in the market. As time passes, consumer needs change, new products are introduced to the market, and old products are discontinued—inventory and sales cycles change. Therefore, even a carefully crafted inventory plan can quickly become obsolete, even on a seasonal basis. Therefore, it is an object of the current system to provide for more efficient gradual methods of re-profiling.

Ideally, an inventory system that could be re-profiled more easily and at a lesser cost to a warehouse would increase that warehouse's productivity by continually locating the most important high-demand products closest to the pickers. The less travel required by the pickers, the greater the efficiency gains. Because of the costs and disadvantages described above as being inherent to the current systems and methods dictate the frequency that re-profiling is carried out, the productivity and efficiency curves become cyclical, starting high immediately following a re-profiling and gradually decreasing until it becomes profitable to re-profile the inventory to achieve gains. Therefore, reducing the cost of re-profiling would allow for significant increases to a warehouse's productivity and efficiency averages, and is a further object of the current invention.

In some circumstances, it can be very difficult, if not impossible, for product replenishment workers to see the guides on the uppermost shelves, as their vantage point may obscure the portion of the guides that sticks out above the shelf. These visual lane position indicators can only be seen above a certain elevation relative to the replenishment side height because they are located within the footprint of the shelf profile. Thus, shorter workers and high shelf positions can contribute to workers having difficulty identifying actual lane positions.

Difficult lane boundary identification can also contribute to, but is not the sole cause of, poorly placed cartons on the replenishment side of a shelf. If a worker that is replenishing a product supply places a carton on the lane askew, the carton can tend to rub against the guide and roll unevenly down the roller tracks due to the increased resistance to motion on one side of the carton. These misplaced cartons will often “hang” on the guides and become stuck before reaching the end of the queue toward the picking side of the shelf. If this happens, a worker must then dislodge the carton to keep the cartons moving and create space for further product. It is therefore another object of the current invention to provide visual lane boundary indicators to warehouse workers replenishing the picking lanes with product.

Typical systems that have been in use for many years are available from a variety of sources, such as Steel King Industries, of Stevens Point, Wis.; Interlake USA of Lexington, Ky. as the “Mecalux” system; Unarco, of Springfield, Tenn.; and Unex of Jackson, N.J. as the “Roller Rack” system.

There is a need in the prior art for the provision of less costly and safer re-profiling of warehousing shelving that will result in more frequent productivity increases. The current invention solves this and other problems to the benefit of warehousing operations.

### BRIEF SUMMARY OF THE INVENTION

The present invention is embodied in a positionable shelf slotter for use with a carton flow shelving system comprising a divider portion for guiding goods into a position on a shelf, with the divider consisting of a blade and a vane; a clip portion with a shelf rail arm, a throat, and a shelf rail bumper, said shelf rail arm configured with a shelf rail retainer, and said shelf rail bumper configured with a bearing plate; with this shelf slotter, the clip portion of the shelf slotter is attachable to a shelf rail by engaging the shelf rail retainer on a first side the shelf rail, positioning the throat across the breadth of the shelf rail and engaging the bearing plate of the shelf rail bumper against a second side of the shelf rail, such that the shelf slotter divider portion is positioned in a generally vertical position generally perpendicular to the shelf.

The shelf slotter can be formed with a blade that extends beyond the shelf rail inner surface. The shelf slotter is further embodied in a shelf slotter that is formed with a flanged edge with a continuous curvature.

The shelf slotters can be installed along a shelf platform without the necessity of removing most of roller tracks that form the shelf platform. The shelf slotter is further embodied in a version that is equipped with an identification tag comprising one or more of a bar code, a two dimensional bar code, a warning light, and a RFID indicator.

The shelf slotter, and particularly the blade and vane can take a variety of forms. In certain embodiments, the blade is extended above the shelf platform, or the shelf slotter can be configured to bridge an impact plate on the shelf platform.

Typically the shelf slotter is formed of resilient material, or has a shelf rail retainer clip of resilient material. In practice, the shelf slotter is formed by one or more of casting, injection molding, machining, and pressing. from one or more of plastic, thermoplastic, polyurethane, metal, aluminum, wood, or wood product.

The shelf slotter clip portion can be provided with a throat that accommodates a wide variety of shelf rail profiles. The retainer holding the shelf slotter on the shelf rail can be integrally formed, be an add-on bearing plate, or utilize other materials such as spring steel to retain the shelf slotter on the rail.

Another embodiment disclosed herein is a system for configuring a carton flow warehouse shelf comprising a replenish side shelf rail, a discharge side shelf rail, and a series of perpendicular roller tracks configured to form a shelf platform with an inclined planar upper surface, with the replenish side of the shelf platform opposed to the discharge side of the shelf platform, with the discharge side of the shelf platform being at lower elevation that the replenish side. Shelf slotters are arrayed to provide carton flow lanes delimited by the shelf slotters mounted at intervals along the replenish side shelf rail. The divider blade portion extends above the upper surface of the shelf platform to create lanes. The system provides for goods to be placed into the carton flow lanes on the shelf platform, as guided by the shelf slotters, with the goods traveling down the shelf platform on the roller tracks such that once the goods are properly directed into the lane by the shelf slotters, the goods travel under the force of gravity down the roller tracks without significant deviation in their path.

A further embodiment of the shelf system is the elimination for the need for traditional fixed lane dividers across the shelf platform. In an alternative embodiment, the shelf slotters are mounted on both the replenish side rail and the discharge side rail, and used to provide an identification or labeling function.

Utilizing the improved system, re-profiling of the shelf platform can be completed without the necessity of removing the majority of the roller tracks forming a shelf platform, and in many situations, can be completed by a single worker. with access only to the replenish side of the shelf platform.

The shelf slotters disclosed van be provided with an identification tag comprising one or more of a bar code, a two dimensional bar code, a warning light, an LED, and a RFID indicator.

The disclosure herein is further embodied in a kit for retrofitting carton flow shelving systems comprising two or more shelf slotters, said shelf slotters further comprising a divider portion for guiding goods into a position on a shelf, a clip portion for removeably attaching the shelf slotter to a shelf rail such that the shelf slotter divider portion is positioned in a generally vertical position generally perpendicular to the shelf, and instructional materials describing the installation of the shelf slotter and reslotting procedure for carton flow shelving systems, wherein the shelf slotter clip portion is configured to be removeably attached to the shelf rails of one or more pre-existing carton flow shelving systems, allowing existing carton flow systems to be reslotted without removing essentially all of a roller bed of a shelf platform. Furthermore, a kit can be provided for testing various shelf slotters with particular shelving system for assisting purchasers in determining their needs for particular forms of shelf slotters.

### BRIEF DESCRIPTION OF THE DRAWINGS

For a fuller understanding of the nature and advantages of the present invention, reference should be had to the following detailed description taken in connection with the accompanying drawings, in which:

FIG. 1 shows a perspective view of a warehouse shelving system using the shelf slotters;

FIG. 2 shows a perspective view of prior art shelving system utilizing existing guide rails;

FIG. 3A-B show a side view of a warehouse shelving system using the shelf slotters and a prior art shelving system utilizing guide rails;

FIG. 4A-B shows top view of a prior art warehouse shelf equipped with a variety of roller tracks and guide rails and a front view of a prior art warehouse shelf indicating the positions of various sizes of boxes;

FIG. 5 shows a top view of shelf slotters placed on a warehouse shelf;

FIG. 6 shows a replenish side view of a warehouse shelving system using the shelf slotters;

FIG. 7 shows a shelf slotter clipped into place on a shelf rail;

FIG. 8 shows the installation of a shelf slotter on a shelf rail;

FIG. 9 shows a shelf slotter installed on a variant type of shelf rail;

FIG. 10 shows an alternative embodiment of a shelf slotter configured for use with a variant shelf rail;

FIG. 11 shows an alternative embodiment of a shelf slotter;

FIG. 12 shows an alternative embodiment of a shelf slotter comprising an extended divider portion;

FIG. 13 shows an alternative embodiment of a shelf slotter comprising an extended clip portion;

FIG. 14 shows an alternative embodiment of a shelf slotter comprising a spring metal shelf rail retainer clip portion;

FIG. 15 shows an alternative embodiment of a shelf slotter for use with an impact panel shelf;

### DETAILED DESCRIPTION OF THE INVENTION

Existing warehouse shelving systems configured for order picking are typified by so-called “carton flow” systems. In a typical carton flow system, a multi-tiered structural rack supports a series of modular shelf rails. The shelf rails are used to support a series of roller tracks that are intended to reversibly snap into notches in the shelf rails, creating a series of slightly inclined platforms of unidirectional wheels or rollers separated by lane dividers. In one configuration, access is available to both sides of the carton flow shelf system, with the higher end of the inclined roller platform available as a stocking aisle for stocking cartons of product, along with a picking aisle for withdrawing stock from the shelf for distribution at the lower end. Thus, warehoused goods are deposited onto the upper end of the roller platform, with the goods able to roll gradually down the inclined platform to the picking aisle. As goods are withdrawn from the picking side of the shelf, additional goods roll down to replace the withdrawn goods.

It is an object of the disclosed system and apparatus to simplify the process of re-profiling (also referred to as slotting and reconfiguring) the lanes of the carton flow shelf. This process is required as the inventory and sales cycles change, the carton flow land dimensions are constantly changing. These changes have to be made to accommodate different box sizes and the popularity of the item, which require more picks from stock by the warehouse workers, and therefore a desirability for the items to be in a position easily accessed by the order picker.

In such a configuration, a carton flow system provides visibility of the stocked merchandise at the pick aisles, and the pick aisles can be are kept stocked from the stock aisle. In this manner picking and distribution can continue simultaneously with restocking. In many warehouses, it is desirable to distribute the oldest stock first, and first-in/first-out (FIFO) traffic of goods from a unidirectional stock replenishment system thus minimizes shelf time.

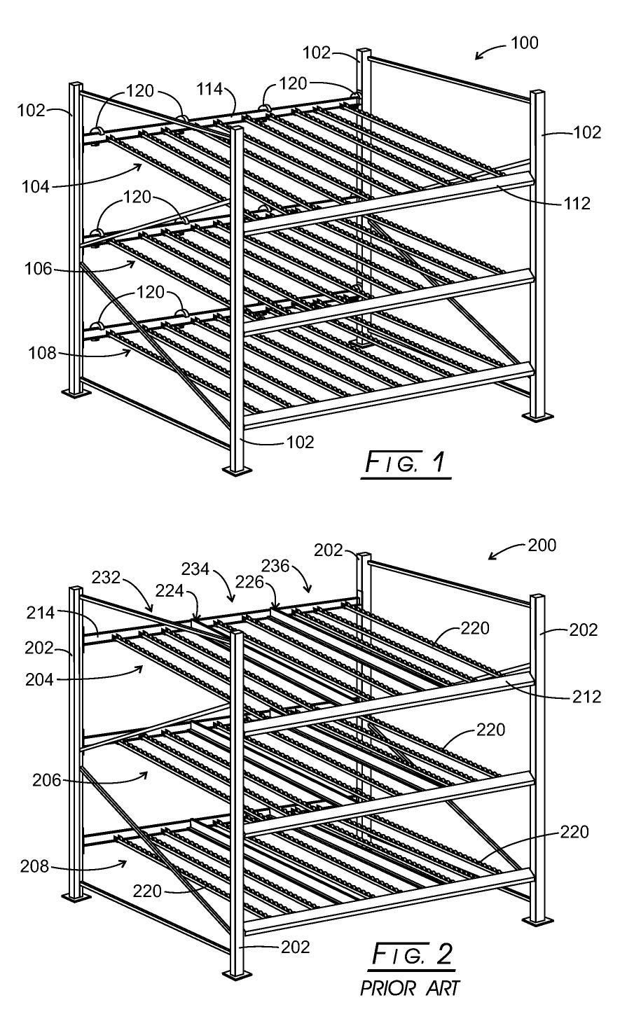

The new system provides for greatly reducing the set-up time for configuring carton flow systems, while essentially eliminating the need for a continuous lane divider. FIG. 1 shows a perspective view of the improved carton flow shelving system 100 and a general view of the system components. FIG. 2 shows a perspective view of a previous modular carton flow shelf system. In FIG. 2 shelving system 200 is comprised of four corner posts 202 supporting three shelf platforms 204-208 respectively. Shelf platform 204 is supported by two shelf rails mounted on the corner posts, with lower shelf rail 212 being generally parallel to upper shelf rail 214. The upper shelf rail is at a higher elevation than the lower shelf rail, and a series of roller tracks 220 are attached at each end to the shelf rails, with the roller tracks being spaced apart to support boxes of various sizes, the roller tracks being mounted parallel to one another. The top surfaces of the rollers on the roller tracks are vertically aligned in orientation, in the manner of a plane, said plane the top surface of the shelf platform. The shelf platform typically also includes one or more lane dividers, i.e., lane guides, such as 224 and 226, that separate groups of roller tracks into lanes, for example lanes 232, 234, and 236, sized to accommodate a particular size of box. Thus, the shelf platform has a generally planar top surface of roller tracks, interrupted by lane dividers, and in use the shelf platform is inclined from the upper shelf rail to the lower shelf rail.

Returning to FIG. 1, shelving system 100 is shown as comprised of four corner posts 102 supporting four shelf platforms 104-110 respectively. Alternative embodiments of the system may utilize additional posts, and cross members to support roller tracks. Moreover, it is apparent the number of shelf platforms, and their individual inclination can be varied as conditions require and space allows. Note that the size of goods placed on the shelf platform will generally determine the amount of space between shelf platforms. Shelf platform 104 is supported by two shelf rails, lower shelf rail 112 and parallel upper shelf rail 114. In the new system, a preferred embodiment is to place the series of roller tracks between the upper and lower shelf rails with a regular spacing across the shelf platform. Although placement of more than the minimum number of roller tracks leads to the need for more roller tracks that are absolutely required, the regular spacing of the roller tracks helps reduce the effort required to reconfigure a shelf. Rather than providing a snap-in lane divider as is typically used in previous systems, as shown in FIG. 1, the new system provides for lanes by mounting a series of shelf slotters, 120 along the upper shelf rail. Goods, typically in boxes, are placed into slots or lanes on the shelf platform, as directed by the shelf slotters. The series of parallel roller tracks allows the goods to travel down the upper surface of the shelf platform. Once the goods are directed into a lane by the shelf slotters, they will travel under the force of gravity down the roller tracks without significant deviation in their path. Thus, the absolute need for a lane divider is eliminated.

The shelf slotter of the present system can be made of a variety of materials—plastics, polymers, resins, metal, and wood. Preferably, the material is somewhat flexible and can return to its original shape (allowing it to snap back into its locked position). The shelf slotters of the system are designed to be attached to any rear, or front, ledge of any type, style, and manufacturer of carton flow systems. The design of the shelf slotter can be altered in overall size to any size or shape depending on the customers' preference and needs for defining lanes in a shelving system. In the most general embodiment the shelf slotter disclosed is made to conform to the profile of a shelf rail, i.e., a shelf ledge and is sufficiently flexible to be able to snap into a locked position. The user simply places the shelf slotter, i.e., the slotting tool or lane indicator, to the desired position on the shelf rail and snaps the tool to the rail using a forward rolling motion. In a preferred embodiment the shelf slotter is removed by reversing the rolling motion used to install the device. Note that although a semi-flexible shelf slotter is desirable, in certain application a rigid shelf slotter may be advantageous, as when the shelf slotter is attached to a shelf rail by adhesive, fasteners or other semi-permanent attachments.

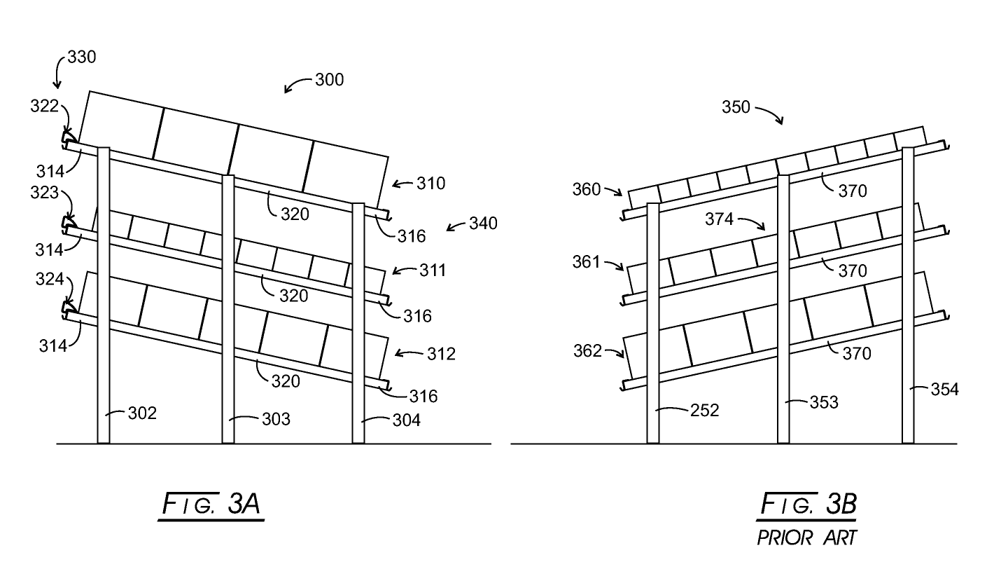

FIGS. 3A and 3B show a comparison of the general arrangement of the shelf slotter system (FIG. 3A) with existing systems using lane dividers (FIG. 3B). Slotter system 300 is shown with three side posts, 302-304, supporting three shelf platforms 310-312. Upper shelf rail 314 and lower shelf rail 316 support a series of roller tracks, as shown generally at 320. As shown in FIG. 3, roller tracks can be further supported by roller track bars (cross members) affixed to posts 302-304 and complementary posts (not shown) on the distal end of the shelf platform. FIG. 3A shows the shelf platform 310 configured for large boxes, shelf platform 311 for small boxes, and shelf platform 312 configured to accommodate boxes or goods of intermediate size. Prior art system 350, as shown in FIG. 3B is illustrative of a number of similar systems, as typified by the system available from Unarco. Carton flow system 350 is shown with three side posts, 352-354, supporting three shelf platforms 360-362. Upper shelf rail 364 and lower shelf rail 366 support a series of roller tracks, as shown generally at 370. FIG. 3B shows the shelf platform 360 configured for small boxes, shelf platform 361 configured to accommodate boxes or goods of intermediate size, and shelf platform 362 configured to accommodate large boxes. In addition to roller tracks 370, are lane dividers mounted along the shelf rails to delineate lanes for travel of carton down the shelf platform.

In FIG. 3A, spaced along the upper shelf rail are a series of shelf slotters, shown generally at 322-324. The upper or higher extremity of the shelf platform (330) is loaded, i.e., stocked, charged or replenished, with goods, and the goods travel down the shelf platform as they are removed, i.e., unloaded, discharged, or picked, from the lower end of the shelf platform (340). The shelf slotters direct the goods into their respective lanes, and the parallel nature of the roller tracks, once the goods are “slotted” directs the boxes down the lane. In contrast, in FIG. 3B, there are no slotters present, and when loading individual lanes on each shelf platform, the stocker must place boxes between lane dividers and align the box with its lane, so that it may travel down the shelf platform.

In most circumstances, shelf platforms are spaced relatively closely together, as with platforms 361 and 362. When most of the stock from a lane has been picked from the discharge side of the shelf platform, restocking leads to the need for boxes to travel a significant distance along the respective lane, and the box may accelerate to more than minimal speed. In such circumstances, if the box is not carefully placed, it may begin to travel down the lane in a skewed fashion, and become wedged against the lane dividers at a location in the interior of the shelving unit, such as the location of the box 374. Alternatively, a box rolling down a lane at more than minimal speed may collide with stock already at rest part of the distance down the shelf platform, and dislodge one or more boxes, so that the boxes are displaced, and unable to continue travel down the shelf lane. In either circumstance, a box wedged at an interior location such as box 374 will be difficult to dislodge, from a full shelf, because there is limited clearance above the boxes, and the wedged box is not readily reachable from either the pick or replenish side. The shelf slotter system reduces the incidence of wedged boxes by reducing or eliminating the need for lane dividers, and also by ensuring that when boxes are stocked, they are place on the roller tracks in a configuration that enhances the parallel travel down the inclined shelf.

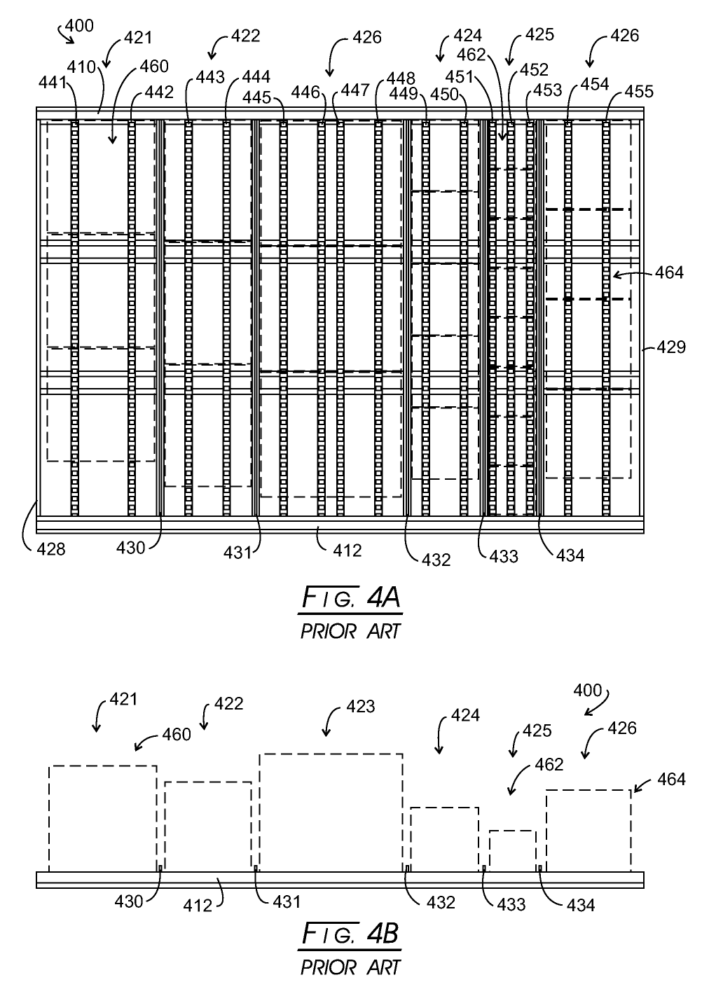

FIGS. 4A and 4B show a top view and a replenish side view of an pre-existing shelf platform 400 configured as is typical in carton flow installations. Looking to FIG. 4A, shelf rails 410 and 412 are shown with a series of roller tracks and lane dividers mounted to them. It is typical in current systems that roller tracks and lane dividers are pressed from thin steel, and the shelf rails are equipped with a series of beveled notches. Compressing the ends of the roller tracks and lane dividers allows the mating of the roller tracks and lane dividers with the notches along the shelf rails. Release of the compression allows the spring action of roller tracks and lane dividers to be retained in the notches on the shelf rails. Typically the notches are spaced about 1 cm apart, allowing the positioning of the roller tracks, for instance at a range of positions along the shelf rails.

A typical carton flow shelf rack is 8′ wide×8′ deep and will provide space for 6-10 ‘lanes’. The lane is occupied by a row of cartons with warehouse products or goods to pick from to fulfill individual orders. As the front carton, the carton at the bottom of the incline towards the “pick” side, is emptied the carton is removed and the next carton behind it rolls down the shelf platform incline (forward) to be picked from. Conventionally, the carton flow shelves use a full-length metal guide, a lane divider, that runs from the rear to the front of the shelf held in place by a variety of methods. This guide is used to delimit the lanes for cartons. Disclosed system nearly eliminates the need for a continuous lane divider

Currently, to re-profile a shelf platform, the roller tracks and lane guides are completely removed from the shelf and are then reinstalled to accommodate the new box dimension or lane position. This process is very labor intensive due to the length (approximately 8 feet) and quantity of roller tracks and lane guides. This process completely stops utilization of the affected carton flow pick area. Using the disclosed shelf slotter system, rather than remove all of the roller tracks, or carton slides and lane guides, the shelf slotter is simply removed from the replenish side shelf ledge, shelf rail, or beam and snapped into a new location on that same shelf ledge. If a roller track needs repositioned to fill a lane, only the directly affected track need be repositioned, not all of the roller tracks in a shelving unit. By re-profiling the shelf platform in this manner, the operation labor costs are greatly reduced and productivity is greatly increased as the re-profiled shelf is available for use in the picking operation much sooner.

As shown in FIG. 4A the lane dividers 430-434 and roller tracks 441-455 are configured to delineate 6 separate lanes, 421-426. Lane 421 is shown with an end guide 428 and a lane divider 430. Two roller tracks 441, 442 are provided to support cartons in lane 421. As shown, a relatively large box, e.g., 460, with low density is supported. Lane 422 shares lane dividers 430 and 431, and is supported by roller tracks 443-444. Lane 423 is provided for a large, dense carton, and is supported by four roller tracks 445-448. Lanes 424 and 426 similarly have two roller tracks and are delineated by lane dividers 432, 433 and 434, along with end guide 429. Lane 425 is configured to support a small, dense box, e.g., 464, and the lane is provided with three roller tracks 451-452. Exemplary cartons are shown in phantom configuration (460, 462, 464).

In FIG. 4B the view from the replenish side shows 410, to which the roller tracks and lane dividers are mounted. Lanes 421-426 are delineated by the positions of lane dividers 430-434. The lane dividers have a rail flange portion and a lane guide portion. In FIG. 4B the lane guide portion of the lane divider projects above the to surface of the shelf platform, separating the cartons occupying the respective lanes. The surface of the shelf platform is created by the top surface of roller tracks mounted on the shelf rails. Thus, the lane dividers separate the individual lanes occupied by a variety of cartons, with the cartons sliding down and being supported by roller tracks.

Warehouse shelving is configured in a manner to place the goods with the highest turnover at the waist level of the order pickers (i.e., warehouse staff) in order to allow the pickers to complete orders with the maximum efficiency. The relative weight of the cartons on carton flow shelving is also a factor in locating cartons of particular goods, such that placement of very heavy goods on low level or high level shelf platforms may be avoided. It is well known the maximum efficiency and relative turnover of stocked goods changes in the market that reduce warehouse order-filling efficiency. To respond to efficiency demands, warehouse managers re-profile (also often referred to as slotting or reconfiguring) the lanes of the carton flow shelves. It is common practice for lanes to be re-profiled on a quarterly or even shorter interval in order to take advantage of productivity gains that result from optimized lane configurations. Existing carton flow shelving of the type shown in FIG. 4 is not well suited for frequent re-profiling. To re-profile a shelving module, each existing lane is emptied of product on the picking side. The roller tracks and guides are then removed from the shelves, and a new profile is created by positioning the guides, tracks, and lane information indicators in accordance with the new plan. The product is then transported to its new location and added to the shelf from the replenishment side.

Accordingly, the roller tracks and guides must be completely removed from each shelf during a re-profiling, and reinstalled to accommodate the new carton dimensions or lane positions. This process presents several problems not solved heretofore by the prior art—problems that affect productivity, safety, and convenience. It is an extremely labor intensive process due to the length and quantity of roller tracks and guides. Multiple warehouse workers must be dedicated to the re-profiling task until the re-profiling process is completed. During these periods the capacity of the warehouse to fill orders decreases, as the workers dedicated to re-profiling cannot participate in the order filling process.

In addition to the significant productivity decreases experienced during a re-profiling period, safety can become a greater concern. The guides that must be removed and reinstalled are often made of thin, folded metal. The edges and corners are often very sharp and pose a significant risk of injury to the workers handling the guides. Hands, fingers, and other body parts can be easily lacerated by these sharp edges. Therefore, the re-profiling process can often result in worker injuries and decreased productivity. Moreover, although the carton flow systems are nominally modular and adaptable to reconfiguration, removal of roller tracks and lane dividers often damages the roller tracks and lane dividers during removal and reinstallation.

Roller tracks are usually manufacturer specific in that they must be purchased from the manufacturer of the shelving unit in order to match the attachment system for the shelf rails. Although not particularly expensive on an individual piece basis, replacement of the removeable shelf components can be a significant expensive when considering the large quantity of components required for a large warehousing operation. Individual roller tracks can cost $8 per track or more, depending on the application. Reducing the damage to components during reconfiguration represents a significant cost savings.

Also, as with most mechanical products, each roller track has an average lifespan. The cost of replacing the roller tracks can thus be reduced by attempting to achieve the highest lifespan yields from the roller tracks. Re-profiling that requires the removal, transportation, and reinstallation of roller tracks significantly reduces the average lifespan of the tracks. Handling the long tracks outside of the shelf can easily result in the tracks becoming bent and useless. Although their individual unit costs are not as significant as the roller tracks, the same is true for the lane dividers that are installed between lanes. Optimizing roller positioning to provide sufficient support for carton to reduce roller track wear and tear.

In order to maintain an ability to respond to market changes more quickly, many warehouse managers maintain open or reserved shelving areas for rapid re-profiling. If products quickly become fast sellers, the empty shelf space can be filled and reconfigured for optimal picking efficiency without disturbing current configurations and picking operations. This eliminates the need to halt picking operations on the shelving units being reconfigured. While the percentage of open (i.e., unused and empty) shelving space relative to the total available shelving will vary from application to application, reserve capacity generally trades total warehouse capacity in exchange for the ability to rapidly respond to market changes. Therefore, it is an advantage of the system to ease reconfiguration and thereby reduce or eliminate the need to maintain reserve shelving, thereby increasing total warehouse capacities.

Additionally, some warehousing facilities re-profile “on the fly” by placing new products in existing lanes. A slower selling existing product might be moved to another area of the warehouse, with its previous lane being reused by the warehouse manager for a product in more demand. The replacement product must be stored in cartons that are equal to or smaller in size than the cartons of the old product being relocated. This allows for piece-meal re-profiling by using existing lane configurations. However, over time, this method can quickly become inefficient as using lane sizes that are larger than the product cartons can result in cartons falling off of the tracks, getting hung up, and because the available space (i.e., between the guides) is not fully utilized.

A substantial labor, and thus warehouse cost savings can be achieved by implementing the shelf slotting system described herein. The labor savings include the reduced time necessary to reprofile a shelf system, and also the labor savings provided by more efficient profiling of the carton flow rack. Table 1 discloses the estimated cost of labor for the present system, using lane dividers, and the improved shelf slotter system disclosed herein. In an exemplary warehouse, with 500 shelf bays and 2000 total shelves, utilizing about 7000 roller tracks, would require an estimated 12000 shelf slotters to fully equip the warehouse. To fully fill the shelf platform with roller tracks, would require an additional 57000 roller tracks. When using staff that generally works as order pickers for the re-profiling process, it takes two workers about 20 minutes to re-profile a single shelf. The estimated labor cost of re-profiling the warehouse would be approximately $225,000. Using the improved system, a shelf can be re-profiled in about 2 minutes by a single worker. The cost for reprofiling the ware house is approximately $12,000. Even the absolute cost of profiling alone, without accounting for lost time picking orders is approximately one half the cost with the new system. This estimate does not include the cost of replacing damaged components present in the previous system, or the improved productivity arising from the ability to re-profile on the fly.

TABLE I
Estimated labor savings for conversion to shelf slotter system.
Shelf Data

| | |
|---|---|
| Bays | 500 |
| Shelves/Bay | 4 |
| Shelf Width (in inches) | 96 |
| Total Shelves | 2000 |
| Average Lanes/Shelf | 7 |
| Current Roll Tracks per Shelf | 14 |
| Current Total Roll Tracks | 7000 |
| Number of shelf slotters required | 12000 |
| Additional Roll Tracks Required to Have Tracks | 57000 |
| on +/−3″ Centers | |

Order Data

| | |
|---|---|
| Average Order or Line Value ($) | 1.00$ |
| Average Order or Lines/Hour Picked | 150 |
| Order Pickers | 20 |
| Avg Hours Pickers Actively Picking per Day | 5 |

Standard Method

| | |
|---|---|
| Time Required to Re-Slot | 20 |
| (Minutes per Shelf) | |
| # Personnel Required to Re-Slot | 2 |
| Average Hourly Labor Rate ($USD) | 20.00$ |
| Total Hours to Re-Slot | 1333 |
| Total Cost to Re-Slot | 26,666.67$ |
| Total Lost Picking Production ($) | 200,000.00$ |
| Total Re-Slot Costs Using Pickers to Re-Slot | 226,666.67$ |

Improved Shelf Slotter System

| | |
|---|---|
| Time Required to Re-Slot | 2 |
| (Minutes per Shelf) | |
| # Personnel Required to Re-Slot | 1 |
| Average Hourly Labor Rate ($USD) | 20.00$ |
| Total Hours to Re-Slot | 67 |
| Total Cost to Re-Slot | 1,333.33$ |
| Total Lost Picking Production ($) | 10,000.00$ |
| Total Re-Slot Costs Using Pickers to Re-Slot | 11,333.33$ |

It is generally estimated, that cost of the replacement shelf slotters and additional roller track could be recovered with in two to 4 re-profiling cycles. Productivity improvements from better shelf profiling are estimated to be at least 10% improvement in order picking efficiency. Numerous industry productivity studies have shown that proper slotting will increase order picking rates from a minimum of 5% up to 20%, while also reducing order picking error rates.

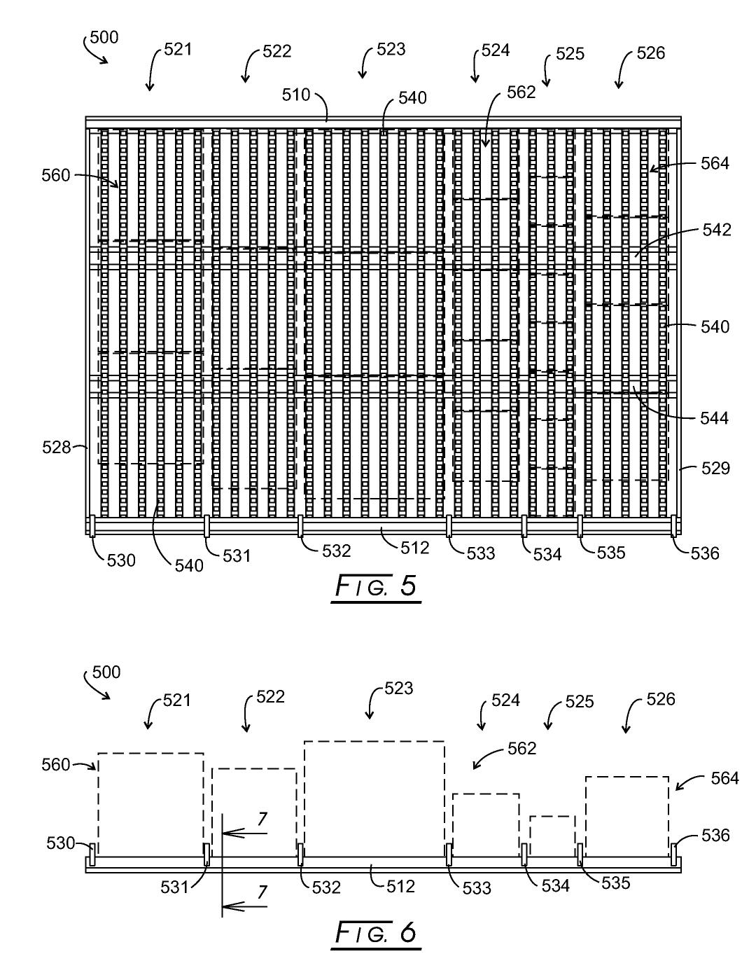

Referring to FIG. 5 and FIG. 6, it will be readily apparent the improvements of the slotting system disclosed herein. In essence the shelf slotters replace lane guides, and nearly eliminate the need to reposition roller tracks during re-profiling. The system allows a single worker to position the shelf slotters on the replenish side of a carton flow shelf, without the use of tools and without disrupting the operation of the carton flow rack.

FIG. 5 shows a top view of an carton flow shelf platform 500 configured platform for carton flow installations modified for use with the shelf slotters and slotting system. FIG. 6 shows a replenish side view of the configuration shown in FIG. 5. Looking to FIG. 5, shelf rails 510 and 512 are shown with a series of roller tracks, 540 and shelf slotters, 530-536, mounted to them. In a variation of installations typical in current systems, the roller tracks are generally distributed along the shelf rails, forming a more or less regularly spaced platform of roller tracks.

As shown in FIG. 5 the shelf slotters 530-436 along with the roller tracks 540 delineate 6 separate lanes, 521-526. Lane 521 is shown also having an optional end guide 528. Shelf slotters 530 and 531 are removeably attached to replenish side shelf rail 512. As cartons 560 are replenished in lane 521, shelf slotters 530 and 531 guide the cartons into a path perpendicular to the shelf rails. Additional shelf slotters (532-536) installed on the shelf rail 512 also guide cartons into their respective lanes. Looking again to lane 521, six roller tracks are provided to support cartons in lane 521. As shown in FIG. 4, the same carton may be adequately supported by as few as two roller tracks. When employing the present system, it is a preferred embodiment that the number of roller tracks installed on a shelf platform should exceed by an acceptable margin the bearing weight of any items placed on a given area of shelf. Thus, there will be sufficient roller tracks installed to support any goods that are slotted for a particular lane, without the need to continually rearrange the position of roller tracks. In addition, a semi-regular placement of roller tracks allows reslotting to occur without repositioning the roller tracks, providing a significant labor savings in re-profiling a carton flow shelf, reduced down-time during re-profiling, and a substantial reduction in the wastage of roller tracks due to damage during removal and re-installation.

Lane 522 shares shelf slotters 531 and 532, and is supported by five roller tracks 540 (for example). Lanes 523, 524, 525 and 526, similarly are delineated by lane dividers 532-536. Lane 526 alternatively, or in addition can be provided with an end guide 529. Also shown in FIG. 5 are cross members 542 and 544. Such cross members are present in some installations to provide additional load-bearing capacity for the roller tracks, as would be provided in connection with the carton flow shelf systems shown in FIGS. 1 and 2. Exemplary cartons 560, 562, and 564 are shown in phantom configuration.

In FIG. 6 the view from the replenish side shows shelf rail 512, to which the roller tracks and shelf slotters are mounted. Lanes 521-526 are delineated by the positions of shelf slotters 530-536. The shelf slotters have a clip portion and a lane guide divider portion. In FIG. 6 the lane guide divider portion of the shelf slotter projects above the to surface of the shelf platform, separating the cartons occupying the respective lanes. The surface of the shelf platform, as before, is created by the top surface of roller tracks mounted on the shelf rails. Thus, the shelf slotters separate the individual lanes occupied by a variety of cartons, with the cartons sliding down and being supported by roller tracks. So long as the cartons are positioned perpendicular to the shelf rail, as guided by the divider portion, the parallel roller tracks will guide carton down the incline of the carton flow shelf platform in a co-parallel fashion.

The clip portion of the shelf slotters grips the shelf rail, and maintains the position of the shelf slotter, delineating a carton flow lane. As noted, the shelf slotter is removeable, allowing re-profiling of the shelf to occur by removing a shelf slotter, repositioning the shelf slotter, reattaching it, and then proceeding to fill the lane with a different size carton. Although it is generally preferable to empty stock from the carton flow shelf before repositioning the shelf slotters, because the parallel roller tracks efficiently direct the carton down the inclined shelf, as soon as a shelf is reprofiled, new lanes are delineated, and replenishing of stock can occur.

The disclosure now turns to a more detailed description of the configuration of a variety of shelf slotters. The previous figures disclose the positioning of shelf slotters on a carton flow shelf assembly. The general requirements for an efficient shelf slotter according to the disclosed embodiments include an attachment system for removeably attaching the shelf slotter to the shelf platform, and a directing system for guiding cartons into a parallel path with the lanes delineated by the shelf slotter.

Thus, the positionable shelf slotter for use with a shelving system such as a carton flow shelving system has a divider portion for guiding goods into a position on a shelf consisting of a vane and a blade, a clip portion with a shelf rail arm, a throat, and a shelf rail bumper. The shelf rail arm is configured with a shelf rail retainer, and the shelf rail bumper is configured with a bearing plate, that increases the retention of the clip portion on the shelf rail. The clip portion of the shelf slotter Is removeably attachable to the shelf rail by engaging the shelf rail retainer on the front side the shelf rail, placing the clip's throat across the breadth of the shelf rail and then engaging the bearing plate of the shelf rail bumper against a rear, interior, side of the shelf rail.

The portion of the shelf slotter that projects above the plane of the upper surface of the roller track bed, i.e., the shelf platform top surface comprises the divider portion of the shelf slotter. The divider portion is comprised of a vane and a blade. The shelf slotter vane is considered the portion of the shelf slotter that projects toward the direction from which cartons are replenished, i.e., the front of the shelf rail. The blade is considered the portion of the shelf slotter that projects toward the carton flow lane, and generally in the direction which cartons will move down the lane. The shelf slotter blade will project above the shelf platform top surface, and divides and separates individual lanes. Installing the shelf slotter as described positions the shelf slotter divider portion in a generally vertical position generally perpendicular to the shelf, with the divider blade projecting into the space above the top surface of the shelf platform.

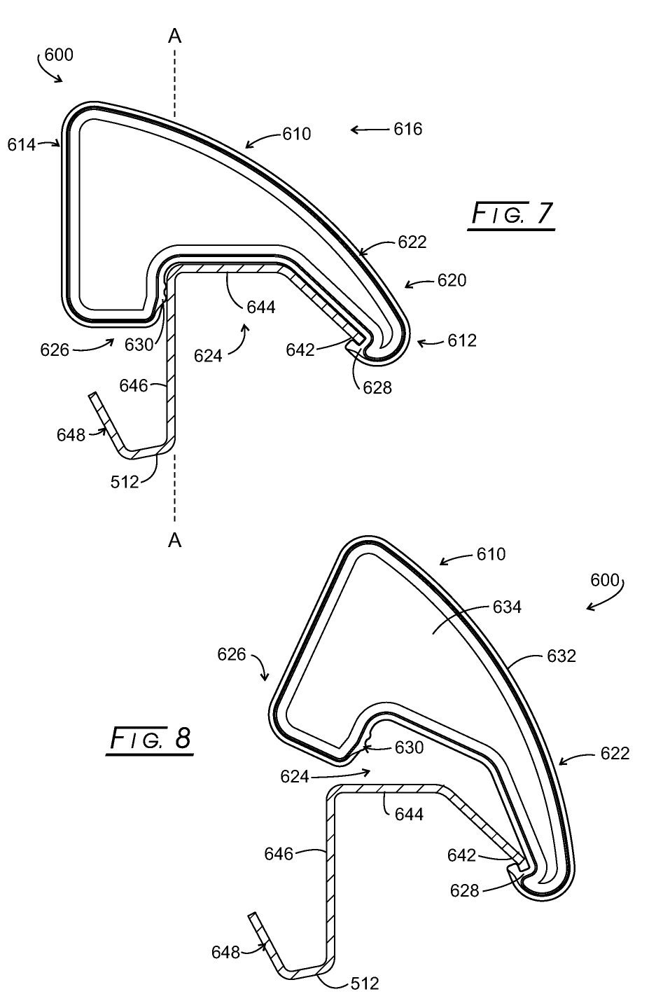

The configuration of one version of the shelf slotter is shown in FIGS. 7 and 8. FIG. 7 shows a shelf slotter engaged on a shelf rail. FIG. 7 represents a cross section of the shelf rail shown in FIGS. 5 and 6 along the plane 7-7 of FIG. 6. In FIG. 7, the positionable shelf slotter 600 has a divider portion 610 for guiding goods into a position on a shelf consisting of a vane 612 and a blade 614. The shelf slotter has a a clip portion 620 with a shelf rail arm, 622, a throat, shown generally at 624 and a shelf rail bumper, shown generally at 626. The shelf rail arm is configured with a shelf rail retainer, 628 and the shelf rail bumper 626 is configured with a bearing plate, 630, that increases the retention of the clip portion on the shelf rail 512. The clip portion of the shelf slotter Is removeably attachable to the shelf rail 512 by engaging the shelf rail retainer on the front side the shelf rail, shelf rail edge 642, placing the clip's throat across the breadth of the shelf rail, the shelf rail top surface 644, and then engaging the bearing plate 630 of the shelf rail bumper against a rear, interior, side of the shelf rail, 646.

Projecting towards the shelf platform from the interior side 646 of the shelf rail, is the roller track channel 648, which provides a location for attaching roller tracks, and is typically configured with notches for retaining roller tracks in position. The cross section of shelf rails varies between manufacturers, and it will be apparent to those skilled in the art that the shelf slotter can be slightly altered within the confines of the present disclosure to be utilized with shelving systems from a variety of manufacturers. The shelf rail cross section shown in FIGS. 7 and 8 is typical of a shelf rail manufactured by Unarco.

The portion of the shelf slotter that projects above the plane of the upper surface of the roller track bed, i.e., the shelf platform top surface comprises the divider portion, 610, of the shelf slotter. The divider portion 610 is comprised of a vane generally at 612 and a blade, generally at 614. The shelf slotter vane is the portion of the shelf slotter that first encounters cartons being replenished on the carton flow shelf, and projects toward the direction from which cartons are replenished. In FIG. 7, cartons are delivered to the shelf in the direction of arrow 616. The blade 614 projects toward the carton flow lane, and generally in the direction which cartons will move down the lane, and thus guides cartons into the proper co-parallel orientation with the roller track axis. As shown the shelf slotter blade will project above the plane of the shelf platform top surface. In such an orientation the blade divides and separates individual lanes at the entrance to the carton flow shelf. The shelf slotter vane projects forward over the shelf rail from the shelf platform. The vane assists those stocking the shelf in accurately locating the appropriate lane, and functions to gather approaching boxes into their respective lanes. Thus, the vane directs the incoming carton stock towards the blade. The shelf slotter blade corrects the direction of incoming cartons, and by the time cartons have passed by the blade, the cartons are straightened and directed down a lane, such that the separate lanes do not interfere with one another, even though no continuous lane divider is present. Note, that in a preferred embodiment, the vane and blade gradually intergrades with one another, and there is no sharp transition between them. In general the shelf slotter blade is considered to include the blade tail portion that projects beyond the line A-A of FIG. 7, that is coincident with the inner face of the shelf rail. The top surface of the shelf slotter is preferably provided with a continuous curvature, so that a slightly off target carton is likely to be redirected by the vane and then the blade into proper orientation for maintaining shelf lanes. Installing the shelf slotter as described positions the shelf slotter divider portion in a generally vertical position generally perpendicular to the shelf, with the divider blade projecting into the space above the top surface of the shelf platform. As shown in FIG. 7, the blade 614 does not extend appreciably inward from the shelf rail. An alternative embodiment of the shelf slotter can be implemented with blades that extend into the area above the shelf platform to more efficiently direct cartons of different sizes, or that vary substantially from a generally cubic shape. As an example, long narrow cartons may require a deeper blade to efficiently maintain lanes.

FIG. 8 shows a shelf slotter that is in the midst of a repositioning procedure. In FIG. 8, the shelf slotter clip portion 620 is disengaged at the shelf rail bumper 626 with shelf rail retainer, 628 of shelf rail arm, 622 being engaged on the shelf rail edge 642 of the shelf rail 512. The Shelf slotter throat, shown generally at 624 is separated from the shelf rail. As previously described, the shelf rail retainer 628 engages the front side the shelf rail, shelf rail edge 642, placing the clip's throat across the breadth of the shelf rail, and the shelf rail top surface 644. The size of the throat is preferably nominally the same or slightly less than the distance between the shelf rail edge and the interior side of the shelf rail, 646. In a preferred embodiment the shelf slotter is formed from a material that is slightly resilient, thus allowing the shelf slotter clip portion to slightly flex in the orientation of the throat. Suitable material may be thermoplastic, hard rubber or similar materials. A plastic shelf slotter is slightly bent to allow the shelf rail bumper 626 to pass by the interior side of the shelf rail, and when the flexed shelf slotter returns to its original configuration, bearing plate, 630, bears against the interior side of the shelf rail, retaining the clip portion and shelf slotter on the shelf rail 512. In an alternative embodiment the shelf slotter can be formed of material that is rigid, or nearly rigid, and the bearing plate can be formed of resilient material, so that compression of the bearing plate allows positioning of the shelf slotter, which is retained by the flexure of the bearing plate itself.

As shown in FIGS. 7 and 8, the shelf slotter can be formed by casting or injection molding, but could be made by machining its shape or alternatively by pressing. Shelf slotter 610 is configured with a peripheral flange 632, which provides a continuous outer surface for the shelf slotter, a surface that is preferably formed to minimize catching of cartons or similar friction-related events. The flange encompasses a plate that comprises most of the divider and clip portions.

Although the flange and plate arrangement offers an advantage in manufacturing the shelf slotters, the flange also serves to provide a grip for installation and removal of the shelf slotter. Moreover, the area of the plate serves a ready location for attaching labels is a protected location, such as bar codes or written signs that indicate the lane position or the contents of a particular lane. Automated scanners can also access bar codes and labels placed on the face of the flange. A slight recess can be formed in the face of the flange to retain such indicators. As warehouse stocking is increasingly utilizing Bluetooth, wireless, RFID (radio frequency identification devices) and other technologies to automate stocking of warehouses, the shelf slotter also can function as a secure location to attach such indicators as RFID chips, either by utilizing adhesives, or a pocket formed in the shelf slotter. It will be apparent that using the shelf slotter as a location for placing labels or other indicators removes the need to have additional label holding facilities associated with the shelf platform, as is now commonly practiced.

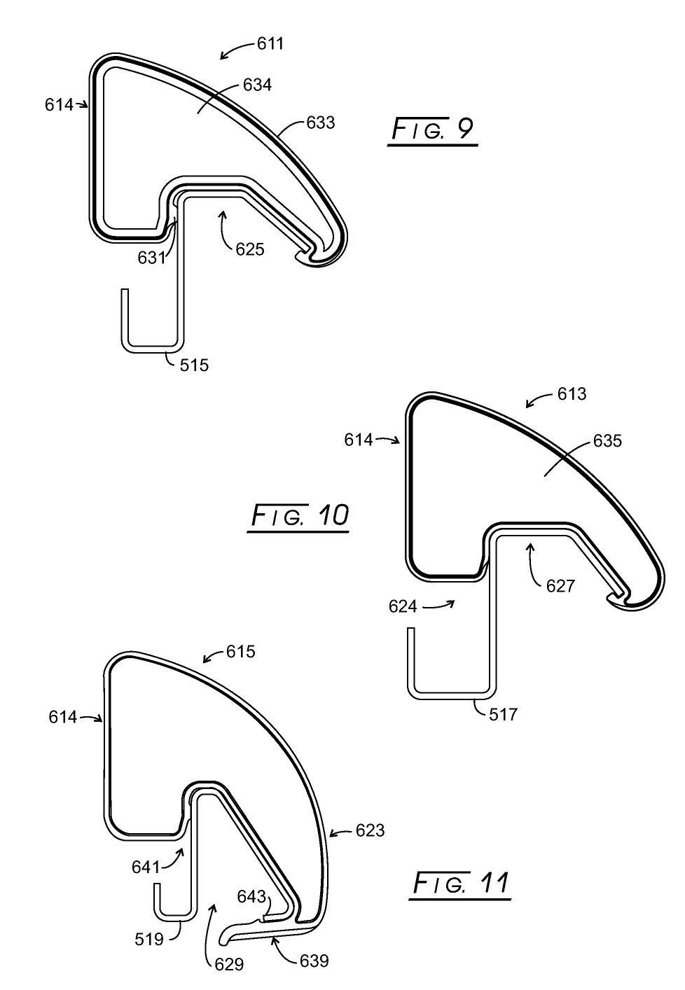

FIG. 9 shows a shelf slotter 611 similar in construction to shelf slotter 610 shown in FIG. 7. Shelf slotter 611 demonstrates that bearing plate 631 can be configured as a simple friction plate, in comparison with the ridged bearing plate 630 of FIG. 7. In addition, shelf rail 515 is of a slightly different configuration than shelf rail 512. So long as the shaped of the shelf rail top plate is similar to the profile of the shelf slotter clip portion throat, 625, the shelf slotter can be utilized with a variety of shelf rails. As shown in FIG. 9, the shelf slotter has a flanged perimeter 633 and narrow plate body 634. Shelf slotter 613, shown in FIG. 10 is similar in arrangement to shelf slotters 610 and 611, but has a reduced bearing plate 633, is mounted to another variant of shelf rail, as at 517 and is configured as a solid body 635, as opposed to a body with a flanged perimeter as shelf slotter 611. A solid body can be cast of metal, formed from plastic, wood, or similar materials.

FIG. 11 shows an alternative embodiment of the shelf slotter, wherein the shelf slotter clip portion throat 629 has a divergent shape to fit on the profile of yet another shelf rail, 519. In each of the heretofore disclosed examples of shelf slotters, the blade portion 614 has a very similar shape. With respect to shelf slotter 615, the divider portion vane 623 is broader and extends further outward from the shelf rail 519 than the vane 622 of shelf slotter 600. Throat 629 is also configured with an extended shelf rail retainer 639, which forms a horn, extending beyond the shelf rail edge 643. With shelf slotter 615, the flexure of the horn portion of the shelf rail retainer is primarily responsible for holding the shelf slotter in place, as opposed to the flexure of the shelf slotter body, or compression of bearing plate 641.

FIGS. 12-14 demonstrate yet more alternative embodiments of the shelf slotter. In FIG. 12 shelf slotter 650 is configured to mount on a box type shelf rail 651. The body of the shelf slotter is formed with a reduced divider vane 656, and a divider blade 654 that extends to a greater vertical extent above the shelf rail 651. Throat 653 is shaped to fit the channel profile of the shelf rail. Shelf rail retainer portion 652 is reduced, in part because the opposing face of the throat bears against and is partially retained by the shelf rail channel. A bearing plate, 655 may be provided at the shelf rail retainer end of the shelf slotter.

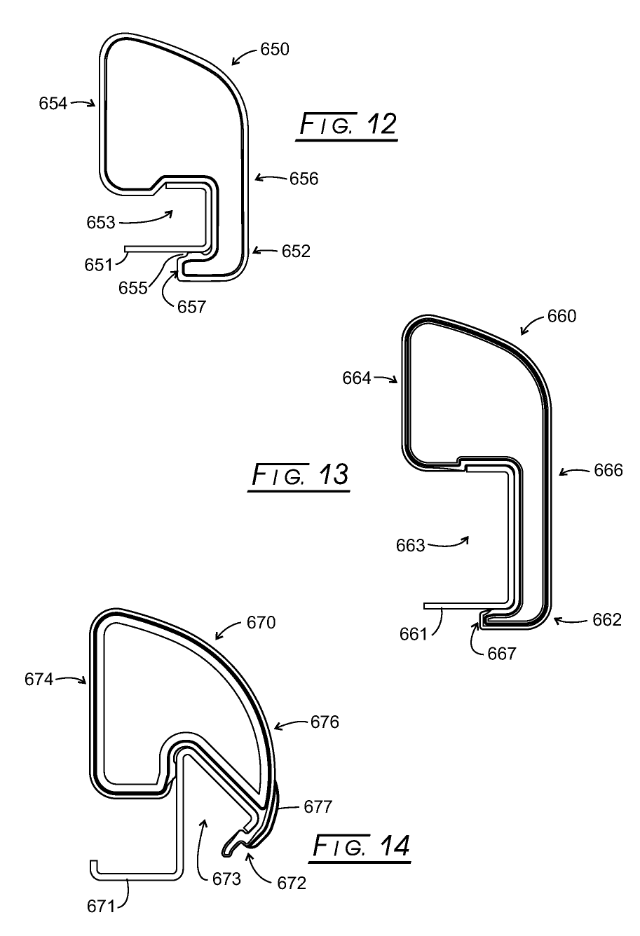

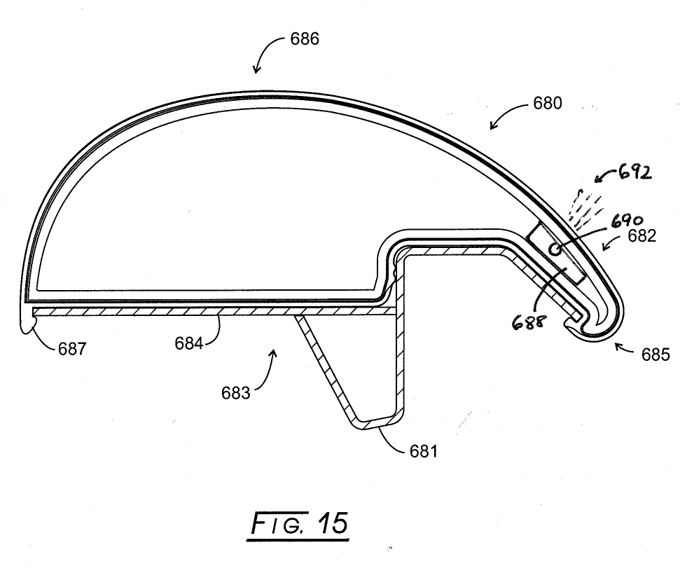

FIG. 13 shows an embodiment of the shelf slotter 660 that is similar to shelf slotter 650, but sized to fit a shelf rail 661 with a deeper rail profile. The divider blade 664 is approximately the same relative size, and the clip portion 666 is extended to the shelf rail retainer 667. Divider vane 662 is reduced. FIG. 14 shows yet another embodiment of the shelf slotter, in this example configured to fit upon a shelf rail 671 with a generally triangular cross section profile, and a provision for a spring metal retainer. Divider blade 674 is enlarged, and divider vane 676 projects to the front of the shelf rail. Shelf slotter throat 673 matches the shelf rail profile, and provides a bearing plate, and the shelf rail retainer 672 is primarily responsible for holding the shelf slotter 670 in place. The shelf rail retainer is reinforced, and forced against the shelf rail by spring clip 677, preferably of spring steel, and slidably attachable to the shelf slotter 670.

Another configuration of carton flow shelving systems are provided to operate with boxes or cartons of substantial weight. Because such boxes are often placed on the shelf platform with a significant force, meaning they are essentially dropped, carton flow shelves can be provided with an impact plate that covers the area of the shelf platform where heavy boxes are placed. In this manner, the roller tracks are not damaged by dropping heavy boxes on them. As shown in FIG. 15, an impact shelf slotter 680 can be configured with an extended throat, 683, and a retainer clip 687 that engages the interior edge of the impact plate 684 in conjunction with shelf rail 681. In this manner the divider blade 684 is extended across the impact plate. As can be recognized by the shelf slotter 680, the divider blade 686 of the shelf slotter can be substantially extended for particular applications, as can the vane portion, such as vane 682. Note that the shelf slotter shown in FIG. 15 is provided with a flange and plate arrangement. Under the recess of the flange, electronic indicator 688 is shown. Indicator 688 can take a wide variety of forms, but a preferred embodiment is that indicator 688 is an RFID chip or a transceiver capable of responding to cues from a stocker, or from the picker's order sheet. LED 690 is shown as part of indicator 688 and said LED can be triggered to be lit, as at 692, when stocking is required, when an order is to be picked from the lane or to register other indications. Those skilled in the art will recognize that the shelf slotter allows warehouse workers to receive a variety of indications that work in conjunction with mechanization and warehouse automations systems.

As has been previously discussed, the shelf slotters disclosed herein are widely applicable to existing shelf rail and roller track systems. In addition, certain carton flow shelving systems are configured with roller beds; slide panels, or moveable belts. In each of these variant systems, a shelf slotter can be implemented to increase the efficiency of replenishing warehouse stocks, particularly for carton flow shelving, but also in some applications for other types of shelving. Implementation of the shelf slotter system can be improved by providing the materials necessary for successful installation in a retrofit or new install kit. A kit for retrofitting an existing carton flow shelving systems would typically contain two or more shelf slotters, but usually sufficient shelf slotters to convert an entire shelf rack, such as shown in FIG. 1. A test kit could also be provided that would allow for conversion of a single shelf platform. Such kit could also contain a variety of available shelf slotters, so that the customer could determine which variation of shelf slotter best fits their needs. Typically instructional materials describing the installation of the shelf slotter system and the re-slotting procedure for carton flow shelving systems would be included in a kit, such materials could be written, on electronic media, or in the form of a video. Use of electronic media could be used to trigger a registration procedure for requesting assistance or demonstration of the system.

While the invention has been described with reference to preferred embodiments, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Since certain changes may be made in the above compositions and methods without departing from the scope of the invention herein involved, it is intended that all matter contained in the above descriptions and examples or shown in the accompanying drawings shall be interpreted as illustrative and not in a limiting sense. In this application all units are in the metric system and all amounts and percentages are by weight, unless otherwise expressly indicated. Also, all citations referred herein are expressly incorporated herein by reference. All terms not specifically defined herein are considered to be defined according to Webster's New Twentieth Century Dictionary Unabridged, Second Edition. The disclosures of all of the citations provided are being expressly incorporated herein by reference. The disclosed invention advances the state of the art and its many advantages include those described and claimed.

We claim:

1. A positionable shelf slotter for use with a shelving system comprising
a divider portion for guiding goods into a position on a shelf;
a clip portion with a shelf rail arm, a throat, and a shelf rail bumper, said shelf rail arm configured with a shelf rail retainer, and said shelf rail bumper configured with a bearing plate;
wherein the clip portion of the shelf slotter Is removeably attachable to a shelf rail by engaging the shelf rail retainer on a first side the shelf rail, positioning the throat across the breadth of the shelf rail and engaging the bearing plate of the shelf rail bumper against a second side of the shelf rail, such that the shelf slotter divider portion is positioned in a generally vertical position generally perpendicular to the shelf.

2. The shelf slotter of claim 1 wherein the shelf slotter is formed with a blade that extends beyond the shelf rail inner surface.

3. The shelf slotter of claim 1 wherein the shelf slotter is formed with a flanged edge with a continuous curvature.

4. The shelf slotter of claim 1 wherein shelf slotters can be installed on a shelf platform without the necessity of removing the majority of roller tracks forming the shelf platform.

5. The shelf slotter of claim 1 wherein the shelf slotter is provided with an identification tag comprising one or more of a bar code, a two dimensional bar code, a warning light, one or more LEDs, and a RFID indicator.

6. The shelf slotter of claim 1 wherein the shelf slotter is configured to bridge an impact plate on the shelf platform.

7. The shelf slotter of claim 1 wherein the shelf slotter has a shelf rail retainer clip of resilient material.

8. The shelf slotter of claim 1 wherein the shelf slotter is formed by one or more of casting, injection molding, machining, and pressing.

9. The shelf slotter of claim 1 wherein the shelf slotter is formed of one or more of plastic, thermoplastic, polyurethane, metal, aluminum, wood, or wood product.

10. A system for configuring a carton flow warehouse shelf comprising
a) at least a replenish side shelf rail, a discharge side shelf rail, and a series of perpendicular roller tracks configured to form a shelf platform with an inclined planar upper surface, a replenish side of the shelf platform opposed to a discharge side of the shelf platform, with the discharge side of the shelf platform being at lower elevation that the replenish side;
b) shelf slotters with a divider portion comprising a vane and a blade, a clip portion with a throat and a retainer;
c) carton flow lanes delimited by shelf slotters mounted at intervals at least along the replenish side shelf rail, said shelf slotters removeably attached to the shelf rails and the divider blade portion extending above the upper surface of the shelf platform; and
d) providing for goods to be placed into the carton flow lanes on the shelf platform, as guided by the shelf slotters;
wherein goods placed into the carton flow lanes travel down the shelf platform on the roller tracks such that once the goods are properly directed into the lane by the shelf slotters, said goods are capable of traveling under the force of gravity down the roller tracks without significant deviation in their path.

11. The system of claim 10 wherein the shelf slotters eliminate the need for a fixed lane divider across the shelf platform.

12. The system of claim 10 wherein shelf slotters are mounted on both the replenish side rail and the discharge side rail.

13. The system of claim 10 wherein the shelf slotter is formed with a blade that extends beyond the shelf rail inner surface.

14. The system of claim 10 wherein the shelf slotter is formed with a flanged edge with a continuous curvature.

15. The system of claim 10 wherein reprofiling of the shelf platform can be completed without the necessity of removing the majority of the roller tracks forming a shelf platform.

16. The system of claim 15 wherein reprofiling can be completed with access only to the replenish side of the shelf platform.

17. The system of claim 10 wherein the shelf slotter is provided with an identification tag comprising one or more of a bar code, a two dimensional bar code, a warning light, and a RFID indicator.

18. The system of claim 10 wherein the shelf slotter is configured to bridge an impact plate on the shelf platform.

19. The system of claim 10 wherein the shelf slotter has a shelf rail retainer clip of resilient material.

20. A kit for retrofitting carton flow shelving systems comprising two or more shelf slotters, said shelf slotters further comprising a divider portion for guiding goods into a position on a shelf, a clip portion for removeably attaching the shelf slotter to a shelf rail such that the shelf slotter divider portion is positioned in a generally vertical position generally perpendicular to the shelf, and instructional materials describing the installation of the shelf slotter and reslotting procedure for carton flow shelving systems, wherein the shelf slotter clip portion is configured to be removeably attached to the shelf rails of one or more pre-existing carton flow shelving systems, allowing existing carton flow systems to be reslotted without removing essentially all of a roller bed of a shelf platform.
